(19) United States
(12) Patent Application Publication
(10) Pub. No.: US 2025/0338296 A1
(43) Pub. Date: Oct. 30, 2025

(54) Mobile Hotspot Solution

(71) Applicant: Nova Labs, Inc., San Francisco, CA (US)

(72) Inventors: Joseph Padden, Boulder, CO (US); Mario Di Dio, Longmont, CO (US); Arsenii Oganov, Kyiv (UA); Oleksander Berezovskyi, Kharkiv (UA); Roman Skochypets, Kyiv (UA)

(21) Appl. No.: 19/191,760

(22) Filed: Apr. 28, 2025

Related U.S. Application Data
(60) Provisional application No. 63/639,579, filed on Apr. 26, 2024.

(51) Int. Cl. H04W 72/30; G06Q 30/0208; H04W 8/02; H04W 24/10; H04W 88/04

(52) U.S. Cl. CPC H04W 72/30; G06Q 30/0208; H04W 8/02; H04W 24/10; H04W 88/04

(57) ABSTRACT

The disclosure generally shows systems and methods for operating a mobile hotspot network using blockchain technology. The system may comprise a mobile hotspot device, backend servers containing a plurality of services, and a blockchain. The mobile hotspot device may generate and collect data usage of the mobile hotspot device or any user devices connected to the mobile hotspot device. Mobile hotspot device may provide such data to the backend servers. The backend server may receive, for each mobile hotspot device, mobile hotspot device data collected by the mobile hotspot device and maintain aggregate data of all mobile hotspot devices. Certain portions of the aggregate data at the backend server may be sent to the blockchain. The blockchain may store mobile hotspot device ownership and receive data concerning transactions involving the mobile hotspot devices.

### CROSS-REFERENCE TO RELATED APPLICATIONS

This application claims priority to provisional U.S. Application Ser. No. 63/639,579, titled “Systems and Methods for a Helium Mobile Hotspot Solution”, and filed Apr. 26, 2024, herein incorporated by reference.

### BACKGROUND

A Mobile Virtual Network Operator (MVNO) typically does not own network infrastructure and may lease the needed network infrastructure from Mobile Network Operators (MNO). These agreements allow an MVNO to utilize network infrastructure, owned by an MNO, including such infrastructure that provides mobile hotspot capabilities. The MNO, as owner of the network infrastructure, receives all the raw data usage records for user devices that connect to the mobile network of the MNO. In these scenarios, an MVNO receives the raw data usage records for the devices that connect to the mobile network of that MVNO. The raw data usage records may relate to information concerning the cellular data usage by a user device (e.g., amount and size of SMS text messages, amount of cellular call minutes, amount of data consumed by all applications on the user device). Additionally, the raw data usage records may include varying forms of subscriber identification information (e.g., IMSI/ICCID/MSISDN). Additionally, where the user devices are connected to a mobile hotspot, the mobile hotspot also produces call data records (CDR) data concerning cellular data consumed by user devices through the mobile hotspot device. Notably, due to regulatory regulations, restrictions may exist regarding who may access customers identifying information, and as such there is a need for a secure, transparent, and efficient way to store and share data with multiple parties.

Both MVNOs and MNOs may offer mobile hotspot capabilities to users of their respective mobile network. As is known in the art, a mobile hotspot may be a standalone device or embedded in certain computing devices (e.g., phone or laptop). The mobile hotspot may convert a cellular signal (e.g., 3G, 4G, 5G) to Wi-Fi and broadcast the Wi-Fi signal. Particularly with 5G cellular signal, due to its high bandwidth, the signal may not cover enough physical distance to provide 5G coverage between MNO 5G cellular towers or nodes. Additionally, there may not be enough capacity at a particular MNO 5G node to provide 5G signal for all devices within range of that node. Thus, there is a need for a system that extends the range of coverage for 5G cellular signals beyond the current MNO infrastructure and may be integrated by an MVNO with the current MNO infrastructure.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. To address the need for secure and transparent system of storing and sharing sensitive data between multiple parties, aspects described herein provide systems and methods for a mobile hotspot solution incorporating a custom blockchain database to store device ownership information and record transactions occurring within the MVNO mobile network.

Aspects described herein provide a mobile hotspot device, which may be controlled by an owner of the mobile hotspot device or personnel of the MVNO Network, or by a network managing party, e.g., a company tasked with development of the mobile hotspot devices, that may interface with existing MNO network infrastructure and may provide users of both the MVNO and the MNO with a broadcasted Wi-Fi signal for data usage. Aspects of the mobile hotspot device may use cellular data paid for by the MVNO in providing a Wi-Fi signal to both the MVNO users and the MNO users. For the MNO users, they will not notice the use of MVNO cellular data when connected to the mobile hotspot device and the device of those users will still operate as if it is utilizing MNO cellular data. The MNO may then track the data usage by MNO users through the MVNO mobile hotspot device and the MNO may pay the MVNO for the data usage by MNO users. Aspects described herein may provide for rewarding owners of the mobile hotspot devices for data usage by MNO users.

Aspects described herein provide a mobile hotspot device and associated network with increased security measures to enable a blockchain identity to live within a blockchain database and further to allow the blockchain identity to be used by trusted software to store accounting events onto the blockchain that may determine and allocate rewards to mobile hotspot devices based on (i) the quality of service offered by the mobile hotspot device and/or (ii) the cellular data consumption of the mobile hotspot device. The quality of service may be determined based on measuring certain network metrics that indicate the quality of the connection being offered by the mobile hotspot device. The cellular data usage may be determined based on monitoring certain accounting data that is gathered for a plurality of mobile hotspot devices.

Aspects described herein provide a custom security framework using a secure boot process that loads, verifies, and executes each image sequentially during the boot process. Additionally, the security framework provides full disk encryption as well as a signed and encrypted operating system (OS) to provide additional layers of security. Aspects of the security framework 102 described herein may provide a trustzone, which is a secured execution environment (e.g., developed by Qualcomm). Aspects of the security framework described herein may establish a “chain of trust” for generating and sharing accounting records that derive from a user connecting to the wireless access point and accessing data on the internet. This chain of trust is important as data usage may be rewarded by the blockchain.

Aspects described herein provide for several onboarding processes tailored to the type of user completing the onboarding. These processes may comprise a bulk-type or individual device-type onboarding process. Generally, in the onboarding process, a mobile hotspot device may broadcast a network suitable to establish a Wi-Fi connection with a user device for completing the onboarding process of the mobile hotspot device. Upon connection to the Wi-Fi, the user device and the mobile hotspot device may communicate and perform any required transactions. The device identity stored in blockchain may be stored as an NFT with a public identity associated with the mobile hotspot device and and a private key associated with the user that owns the device.

Aspects of the hotspot device may ping the blockchain for verification that the hotspot device's public key is associated with a user's private key. Upon verification the hotspot device has a public-private key pair on the blockchain, the hotspot device migrates from on-boarding mode to operational. In previous systems, the number of hotspot devices is often sequential and easily guessable and when connected to the internet may be open to a bad actor claiming ownership of a hotspot device that does not belong to the bad actor.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 illustrates an example system of some illustrative aspects described herein.

FIG. 2 illustrates aspects of a secure boot process, according to one or more illustrative aspects described herein.

FIG. 3 illustrates aspects of the telecommunication framework utilized in operation of the mobile hotspot architecture, according to one or more illustrative aspects described herein.

FIG. 4 illustrates aspects of an interface of an example application or dashboard, according to one or more illustrative aspects described herein.

FIGS. 5A-C illustrates aspects of an interface concerning the fleet management application 112, according to one or more illustrative aspects described herein.

FIG. 6 is a diagram that illustrates aspects of the process for manufacturing mobile hotspot devices.

FIG. 7 is a diagram that illustrates additional aspects of the process for manufacturing mobile hotspot devices.

FIG. 8 is a diagram illustrating aspects of bulk-type onboarding for hotspot devices.

FIG. 9 is a diagram illustrating additional aspects of bulk-type onboarding for hotspot devices.

FIG. 10 is a diagram illustrating aspects of individual-type onboarding for hotspot devices.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning.

Aspects described herein provide a secure mobile hotspot device that leverages blockchain technology to provide 5G and/or other radio services to third parties. The mobile hotspot device may extend cellular data coverage (e.g., 5G) of current infrastructure for MVNO subscribers and/or subscribers of partners to the MVNO. The mobile hotspot may be owned by any third party (e.g., an individual, a company, etc.), and ownership may be stored on a blockchain, based on a wallet address on the blockchain owning an NFT associated with the mobile hotspot. When a mobile subscriber accesses a mobile hotspot, the mobile subscriber's telephony carrier may pay the owner of the mobile hotspot a fee based on the amount of data the mobile subscriber communicates over the mobile hotspot. Such payments may be made via the blockchain. Ownership of the mobile hotspot device does not require that the owner be a subscriber of the mobile network(s) on which the mobile hotspot operates. An entity may own a mobile hotspot device independent of that entity's association with the MVNO or any previous blockchain identities. Similarly, telephony subscribers can use a mobile carrier (e.g., MVNO) that offloads data to the described mobile hotspots without having to own or even know anything about the described mobile hotspots. Similarly, users of the blockchain on which the mobile hotspot data is stored and data usage-based payments are made do not need to own any mobile hotspots or subscribe to any MNO or MVNO that offloads data onto one or more mobile hotspots. Ownership of a mobile hotspot device, subscription to a mobile network that offloads data to mobile hotspots, and/or establishing a blockchain identity are independent and discrete aspects of the example systems described herein. They are neither dependent on each other nor mutually exclusive. A single entity could do none, one, two, or all three.

The mobile hotspot device system described herein may provide separate and unique software applications concerning functionality for (i) mobile hotspot device owners (fleet management application), (ii) MVNO mobile network subscribers (mobile subscriber application), and (iii) blockchain users (wallet application). The applications, and any functionality within each, may be separate or there may be some functional overlap, based on what each type of user needs to do. As an example, an end user may own a mobile hotspot device without being a subscriber to the MVNO mobile network and the end user may interact with the fleet management application concerning functionality for mobile hotspot device owners. This same end user may interact with the wallet application for user blockchain wallets to check and receive blockchain payments based on third-party usage of its mobile hotspot(s). As another example, a different end user may be a subscriber to the MVNO mobile network but does not own a mobile hotspot device. This subscriber may interact with the mobile subscriber application, but does not need to interact with the fleet management application. If that subscriber has previously created a digital wallet, the user may use the wallet application as well, and/or the subscriber application may also provide or include some blockchain wallet functionality as well. These examples illustrate that each aspect of the system, and each application for the functionality relating to those aspects of the system, may be independent from the other aspects and different types of end users may have differing interactions with these independent aspects of the system, based on their own respective uses of the network described herein.

### Blockchain Technology

Blockchain is a decentralized digital ledger that allows multiple parties to engage in secure, trusted transactions with one another without an intermediary. A blockchain database may consist of a series of digital “blocks” that are securely linked together in sequential order using cryptography to create a virtual chain of data. The blocks may record information such as financial transactions, agreements between parties, and ownership records. A blockchain may run on a distributed network of computers. Computers in the network, also referred to as nodes, store copies of the blockchain, validate that the blockchain has not been tampered with, and verify when transactions can be added to a new block. Nodes share and synchronize all updates. Finally, blockchains maintain agreement between participants using a “consensus protocol” that is a set of rules allowing nodes to determine when to add new information to the blockchain. Consensus protocols are designed to make the blockchain resistant to tampering and ensure consistency in the data among all participants in the network. The decentralized digital ledgers ensure each computer in the network has identical records.

Non-fungible tokens (NFT) are unique digital token identifiers that are recorded on a blockchain. The NFT may certify ownership and authenticity as the unique digital token identifier cannot be copied, substituted, or subdivided. NFTs are created through a process called minting, which involves signing a blockchain transaction that outlines the fundamental token details, which is then broadcast to the blockchain to trigger a smart contract function that creates the token and assigns it to its owner. The NFTs unique digital identifier is mapped to an owner identifier that is stored inside a smart contract. When the owner of an NFT wishes to transfer it to another user, it is easy to verify ownership and reassign the token to a new owner.

Smart Contracts are code that is executed deterministically in the context of a blockchain network, meaning each participant in the network verifies the state-changing operations of the smart contract. Smart contracts can store small amounts of data in common data structures, which is a critical component of tokenization use cases that map token identifiers to owner identifiers to track who owns which token.

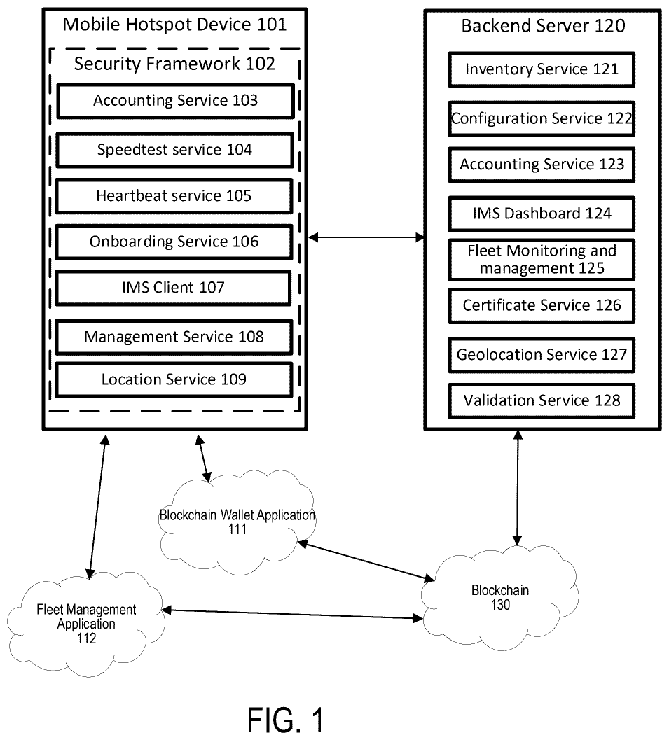

FIG. 1 illustrates an example system 100. Aspects of system 100 described herein may include mobile hotspot device 101, blockchain wallet application 111, fleet management application 112, backend server 120, and blockchain 130. Aspects of mobile hotspot device 101 described herein may include security framework 102 and services 103-110, which are further described below. Aspects of backend server 120 may include services 121-129, which are further described below.

Aspects of the mobile hotspot device 101 described herein may comprise several software services that provide different functionalities for the mobile hotspot device 101. Aspects of the software services may provide an: accounting service 103, speedtest service 104, heartbeat service 105, onboarding service 106, IMS client 107, management service 108, location service 109, and manufacturing service 110. Additionally, aspects of mobile hotspot 101 may provide a security framework 102 to ensure trusted and secure communications between the different components of the system 100. Mobile hotspot device 102 may digitally sign generated data with its own private key so that such data may be validated and verified by components of the system that communicate with blockchain 130, resulting in data being stored on the blockchain.

Aspects of the accounting service 103 described herein may provide for generating and collecting data usage of any user devices connected to the mobile hotspot device 101. Data usage may be associated with user devices by the particular MAC address of the user device. The mobile hotspot device may then generate the collected data usage records, often termed call data records (CDR). The accounting service 103 may normalize the CDR data generated to have similar data structure as an aggregate log file within inventory service 121 of backend server 120. Aspects of the CDR data described herein may indicate the data usage of a user device connected to mobile hotspot device 101, such data usage may comprise: (i) data concerning the number and size of text messages sent and received by the user device, (ii) data concerning the number of minutes spent talking and amount of phone calls made or received by the user device, (iii) the amount of data consumed from use of different applications on the user device. Additionally, the CDRs may include any associated meta-data. The mobile hotspot device 101 may, prior to sending the CDR data, digitally sign the CDR data so the backend server 120 may verify and validate the CDR data. Aspects of the speedtest service may provide testing capabilities to monitor the network connection status of the mobile hotspot device 101.

Aspects of the heartbeat service 105 described herein provide for generating a heartbeat message that may contain metadata about mobile hotspot device 101 (e.g., a time stamp, test status, and/or details about mobile hotspot device 101 such as a location of the mobile hotspot device 101). Aspects of the heartbeat service 105 may send the generated heartbeat message, with any metadata, to blockchain wallet application 111 and/or blockchain 130.

Aspects of the management services 108 may provide a user the ability to manage (i) what device and/or network metrics are being monitored, (ii) configuration of a fleet of mobile hotspot devices, (iii) generate a log of devices that are whitelisted from connecting to the mobile hotspot and revise such log as needed. Management service 108 may provide monitoring of the hotspot device and manage firmware updates, update user defined parameters of the hotspot device.

Aspects of the location service 109 may provide a location utilizing global positioning satellite (GPS) data to verify the location of the mobile hotspot device 101. Location service 109 may also verify the location of the mobile hotspot device 101 by deriving the location from data provided to blockchain 130. For example, a location mapping service may be executed on user devices that independently verifies the location of mobile hotspots when a user device detects and communicates with the mobile hotspot, based on the location of the user device. Location service 109 may thus determine whether an observed location of mobile hotspot 101 is different than the location derived from data provided to blockchain 130 when the mobile hotspot was deployed or reconfigured. The location service 107 may periodically determine the location of the mobile hotspot device 101. Aspects of the location service 109 may utilize different forms of location data to authenticate the location of the mobile hotspot device 101.

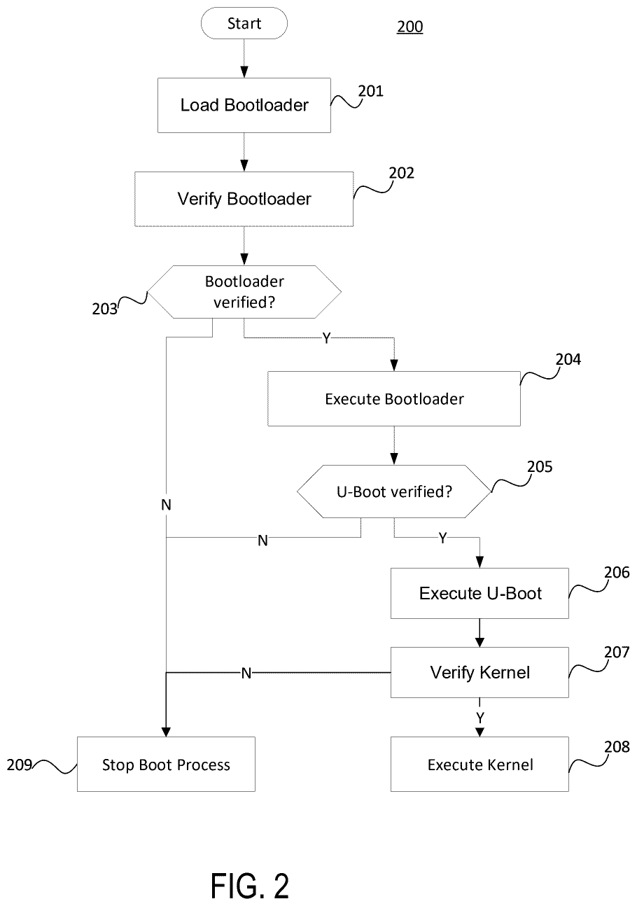

Additionally, mobile hotspot device 101 described herein may provide for a security framework 102 encompassing device security for mobile hotspot device 101 and associated services 103-110. FIG. 2, described in detail below, illustrates aspects of a boot process that may be implemented by security framework 102. The underlying code executing for each service 103-110 during operation of system 100 is trusted because security framework 102 may develop the chain of trust by incorporating the key-pairs generated for each service and stored within a trustzone established by the security framework 102 and executing a secure boot process as described in FIG. 2.

Aspects of the security framework 102 described herein may comprise the following building blocks: (i) trustzone—a security execution environment, e.g., developed by Qualcomm, (ii) secure boot process, (iii) full disk encryption, and (iv) mTLS communication protocol. Aspects of the trustzone may provide a trusted environment for security framework 102 to execute and mobile hotspot device 101 may have certain device identification information that is stored only within the trustzone environment and available as fuse data. Fuse data, as described herein, may provide a one-time programmable key that may be used to perform encryption security of all derivative keys which are stored and used by mobile hotspot device 101. The encryption algorithm may be based on RSA 2048, ASK 256, or the like. Mobile hotspot device 101 may use the one-time programmable key to digitally sign data so other parties that receive the data may authenticate such data as originating from mobile hotspot device 101.

Aspects of security framework 102 may use mutual authentication mechanism (mTLS) to authenticate connections between mobile hotspot devices 101 and services within backend server 120. Aspects of mTLS described herein may provide for not only encrypted communication but also trusted communication between mobile hotspot devices and services within backend server 120.

Aspects of the trustzone described herein may provide for creating and storing two private/public key pairs. One private/public key pair is associated blockchain ownership and transactions, while the other private/public key pair is for infrastructure security and data usage transactions. The first key pair associated with blockchain ownership and transactions may have an associated public key (e.g., an NFT) that is published and viewable on the blockchain 130. The private key, of the key pair associated with blockchain ownership and transactions, may be associated with the mobile hotspot device to prove ownership of the public key and may be used as a digital signature for any blockchain transactions (e.g., heartbeat data, speed test data, location data).

Aspects of the second key pair associated with infrastructure security and data usage transactions may utilize the private key to add a digital signature to the end of data usage transactions, which allows the services within backend server 120 to verify and validate the data is being received from a trusted mobile hotspot device.

Aspects of the mobile hotspot device 101 described herein may provide for a transition in device configuration between the on-boarding mode and the operational mode of the hotspot device. Upon successful on-boarding, the hotspot device may shut down the on-boarding Wi-Fi signal initially generated for the on-boarding process and may communicate with a configuration server that enables the hotspot device to generate an operational Wi-Fi signals and connect with all the relevant backend services (e.g., fleet management, fleet monitoring, accounting services).

Aspects of blockchain wallet application 111 described herein may provide functionality to view blockchain wallets associated with an end user. Blockchain wallet application 111 may provide further functionality for an end user to check and receive blockchain payments based on third-party usage of a mobile hotspot device 101. An end user of blockchain wallet application 111 does not need to be the owner of a mobile hotspot device 101 to use blockchain wallet application 111. However, users who do own one or more mobile hotspots, e.g., by owning an NFT representing a mobile hotspot, would have access to additional features and/or functionality of the wallet application claim rewards earned by that user's mobile hotspot(s).

Aspects of fleet management application 112 described herein may provide an interface to an end user for view and/or providing user input during the onboarding process. Aspects of the fleet management application 112 may provide a query service for the user to determine the onboarding status of mobile hotspot device 101.

Aspects of backend server 120 described herein may comprise several software services that provide functionality for backend server 120. Such services may comprise: inventory service 121, configuration service 122, accounting service 123, IMS dashboard 124, fleet monitoring and management 125, certificate service 126, geolocation service 127, validation service 128, and manufacturing service 129.

Aspects of inventory service 121 described herein may provide a database for storing and maintaining data concerning a plurality of mobile hotspot devices 101 within the MVNO network. Aspects of the inventory service described herein may allow the backend services and hotspot services to understand the particular aspects of the configuration file that should be configured based on the device attributes.

Aspects of configuration service 122 described herein may store configuration for different device types and when a user connects to mobile hotspot device 101, the device will communicate with the backend system configuration service 122 to obtain the configuration file the hotspot device.

Aspects of the accounting services 123 described herein provide receiving and processing raw CDR data from a plurality of mobile hotspot devices generating CDR data. Additional aspects of the accounting services 110 may provide sending accounting data to the custom blockchain 114. Additionally, accounting service 123 may apply business logic (e.g., a rule set for rewarding mobile hotspot devices based on data usage and/or network metrics) to CDR data stored at accounting service 123. As an example, an MVNO may implement a data reward cap that may be dependent on the price plan of a particular user and the amount of rewardable gigabytes the user can generate per month. In that scenario, accounting service 123 may be applying business logic concerning various business accounting rules (e.g., are you allowed to generate more rewards for this data) that determine rewards associated with a particular mobile hotspot device. Aspects of the rewards may be paid out to subscribers on a periodic basis (e.g., daily). Generally, accounting service 123 may implement business logic concerning the application of certain accounting rules, monitoring mobile hotspot devices to determine if they are storing the proper data, and monitoring data received from mobile hotspot devices to determine if such data aligns with storage of aggregate CDR data at accounting service 123.

Aspects of fleet monitoring and management 125 described herein may provide aggregate monitoring information for fleets of mobile hotspot devices 101. “Fleet” may represent a grouping of all the mobile hotspot devices owned by a single user. Additionally, the fleet monitoring and management 125 may receive user data from the management service 108. Such user data may comprise changing monitoring of certain device and/or network metrics for every mobile hotspot device in a user's fleet. In this situation, fleet monitoring and management 125 may communicate the user data to the entire fleet of mobile hotspot devices. Fleet monitoring and management 125 may provide an updated device configuration to the fleet of mobile hotspot devices.

Aspects of certificate service 126 provide for generating certificate data during the onboarding process for a new mobile hotspot device. Certificate service 126 may receive and respond to queries from inventory service 121.

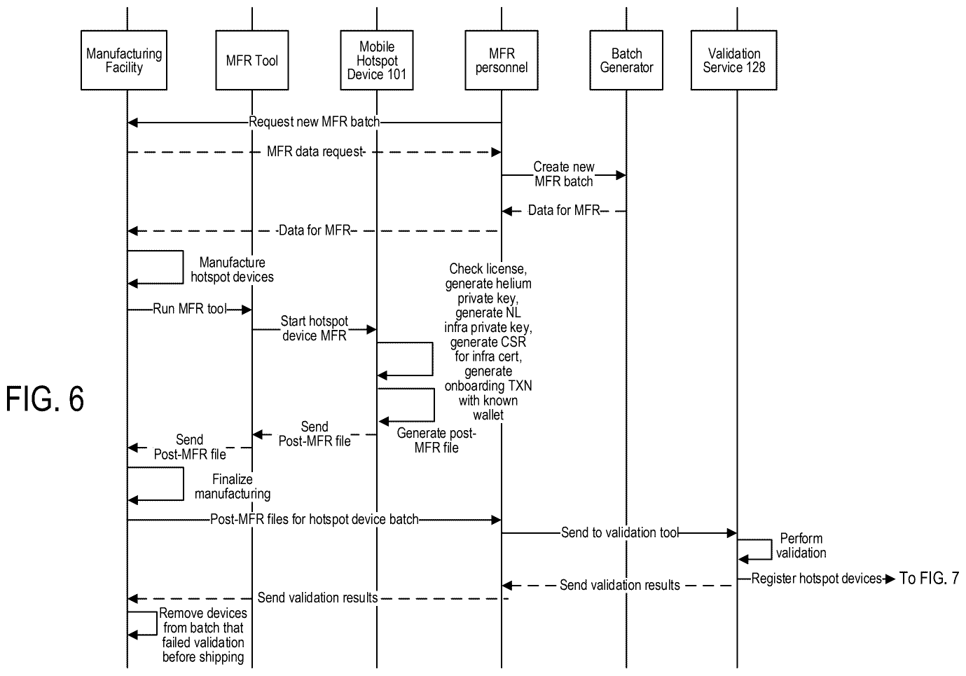

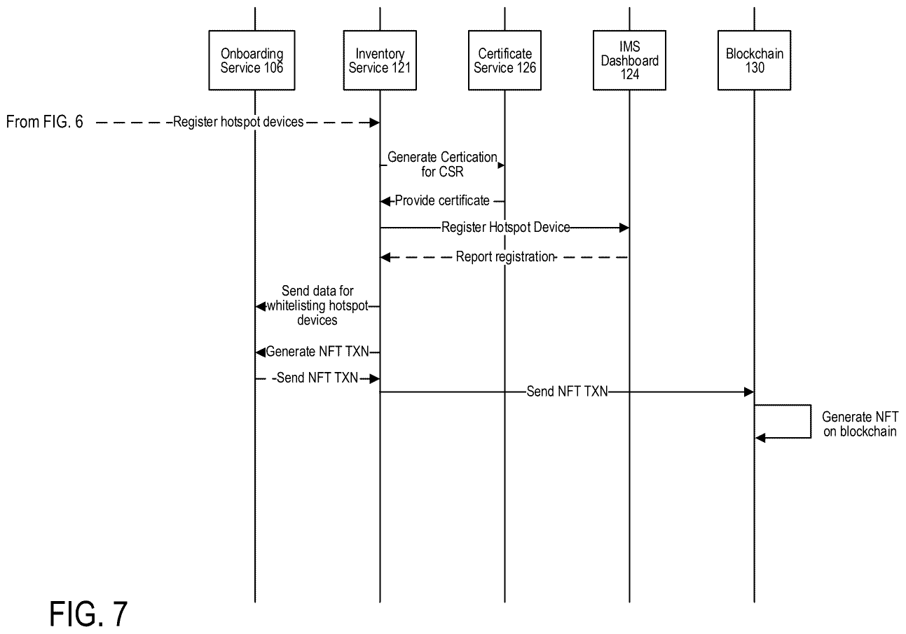

Aspects of validation service 128 described herein may provide for authentication of newly manufactured mobile hotspot devices during the manufacturing process, described below in FIGS. 6 and 7.

Aspects of blockchain 130 described herein may provide capabilities for storing ownership information as unique decentralized tokens and maintaining a digital decentralized ledger for transactions involving the different mobile hotspot devices on the blockchain. The unique decentralized tokens may be generated as NFTs. Aspects of blockchain 130 may comprise existing blockchains, such as the Solana blockchain or any other suitable blockchain that may provide smart-contract functionality.

Aspects of FIG. 2 described herein may provide a process for a secure bootup process with a fully trusted boot chain process, commonly known as chain of trust booting. The secure bootup process is a bootup process where every stage of bootup is loaded, verified (e.g., with RSA 2048 or AES 256), and then executed before completing the same process for the next stage of the bootup process. Secure bootup process 200 begins with mobile hotspot device 101 powered up from a rest state (e.g., device powered off). At step 201 an initial bootloader is loaded, then at step 202 the initial bootloader may be verified. The initial bootloader may be embedded within the hardware of mobile hotspot device 101 containing the digital signature encrypted using methods such as RSA 2038 key generation and signature or AES 256 key generation. The secure bootup process 200 may then verify the digital signature of the initial bootloader. If the initial bootloader is not verified at step 202, the process moves to step 209 and stops the boot process. If the initial bootloader is verified, the process moves to step 204 where the initial bootloader is executed. At step 205, the U-Boot is verified using similar methods described above. If U-Boot is not verified, the process moves to step 209 and stops boot process. If the U-Boot is verified, the process moves to step 206 where the U-Boot is executed. The U-Boot does not need to be encrypted similar to the initial bootloader. At step 207, the kernel is verified using similar methods described above. If the verification fails, the process moves to step 209, stop boot process. If the kernel is verified, the process moves to step 208 and the kernel is executed.

Aspects of the kernel described herein may be bundled with the operating system. The combined kernel and operating system may be a single binary that is fully encrypted on the storage of the hotspot device using full disk encryption. As an example, using full disk encryption for the combined kernel and operating system, a potential attacker could not cause disorder with any device components, like memory, because when read by the potential attacker it will be viewed as random bytes since the mobile hotspot device 101 may be encrypted with full disk encryption. Additionally, every mobile hotspot device has its own RSA 2048 certificate that was issued by the MVNO certificate service 126. The RSA 2048 certificate may only be available through the trustzone and provide for authentication and authorization of the mobile hotspot device.

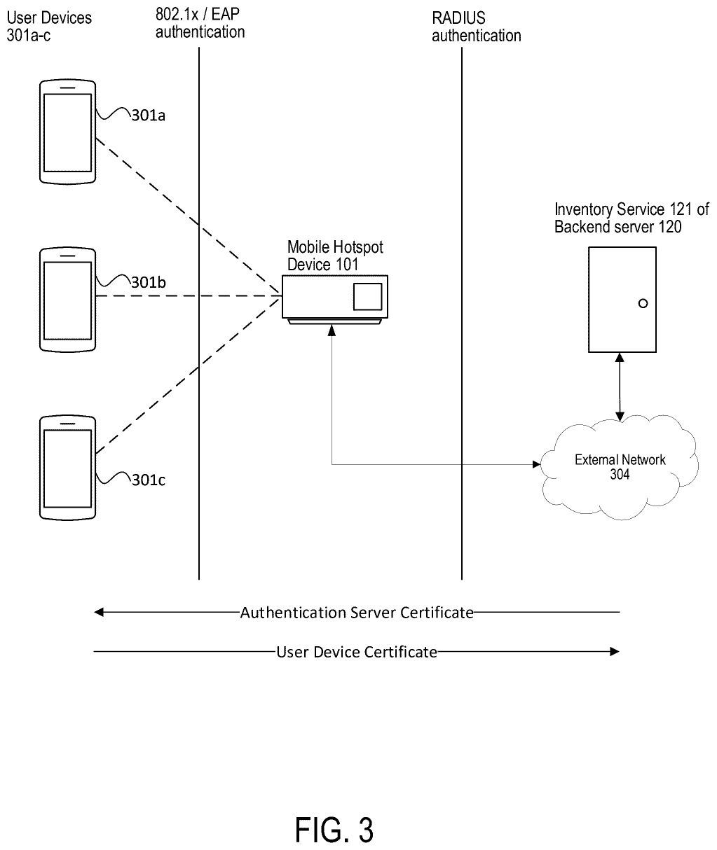

Aspects of FIG. 3 described herein provide an example of the telecommunication framework for providing aspects discussed herein. User devices 301a-c may attempt to connect to mobile hotspot device 101. The user devices 301a-c may supply user device certificate information to mobile hotspot device 101. Between user devices 301a-c and mobile hotspot device 101, any suitable authentication protocol may be utilized such as EAP-TLS or EAP-AKA, and may be dependent on the network topology. Aspects of the EAP authentication may provide creation of individual key-pairs that are stored in a secure enclave within the mobile hotspot device. Mobile hotspot device 101 may communicate with inventory service 121 to provide the certificate information. Aspects of the inventory service 121 may store user information in a local database or may retrieve subscriber information from a database separate from inventory service 121. Between the mobile hotspot device 101 and inventory service 121, a Remote Authentication Dial-in User Service (RADIUS) protocol may be to authenticate communications between those devices. The inventory service 121 may communicate an authentication certificate to mobile hotspot device 101 that indicates user devices 301a-c are trusted user devices and may connect to the mobile hotspot device 101. Upon connection to the wireless network of the mobile hotspot device 101, a Passpoint2.0 profile may be generated and maintained for each user device to deliver all the required data and configuration to the user devices 301a-c.

Aspects of the telecommunications framework 300 may provide for authenticating a user device belonging to a partner of the MVNO. The user device belonging to a partner of the MVNO may connect to the mobile hotspot device 101 based on the SIM card installed on the user device and may not require other security aspects previously described. In this scenario, the mobile hotspot device 101 may send an authentication message to the inventory service 121 that may forward the data to the partner backend systems, and those partner backend systems may indicate if the device is verified to connect to the hotspot device.

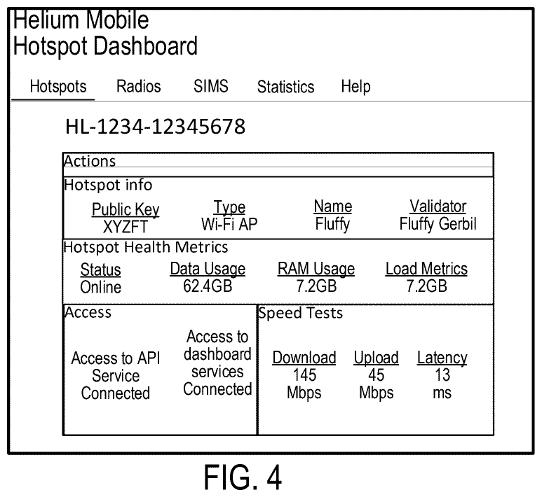

FIG. 4 illustrates an interface of an example application or dashboard (e.g., a manufacturing application or a device dashboard). The interface of an example manufacturing application or dashboard may provide device information, monitoring metrics, and testing metrics of a particular hotspot device. The device information may provide a public key, the type of device, the name of the device, and the validator. The example interface may also provide hotspot health metrics that may indicate the status, data usage, RAM usage, and/or load metrics. The example interface may provide access status concerning the mobile hotspot device's connection to relevant components of the mobile network. The example interface may provide a specific indicator of speed test results that may comprise the download/upload speed and latency measurements.

Aspects of the interface of an example application or dashboard (e.g., a manufacturing application or a device dashboard) may display a list of any whitelisted devices (e.g., whitelisted mobile hotspots) and may receive input concerning any changes to the list of whitelisted devices (e.g., adding or deleting whitelisted device). As is known in the art, whitelisting devices describes generating a list of approved devices that may access a mobile network, with all other devices denied access by default. Further aspects of the interface of an example application or dashboard (e.g., a manufacturing application or a device dashboard) provides storing and maintaining a list of individual mobile hotspot device keys.

Additional aspects of the interface of an example application or dashboard (e.g., a manufacturing application or a device dashboard) provide management and configuration capabilities such as over-the-air (OTA) firmware or software updates and/or OTA device configuration updates. Further, an example application or dashboard may provide capabilities such as a device fleet management system, a user management cloud dashboard, and monitoring for anomaly detection and alerting. It should be understood that the functionality described in relation to FIG. 4 may include further components to facilitate the described functionality (e.g., a data server for the underlying information shown in the interface of an example application or dashboard) and may provide an overlap in certain functionality with the other components described herein.

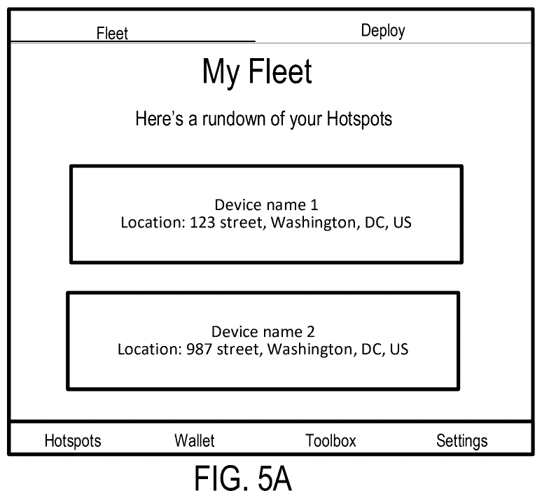

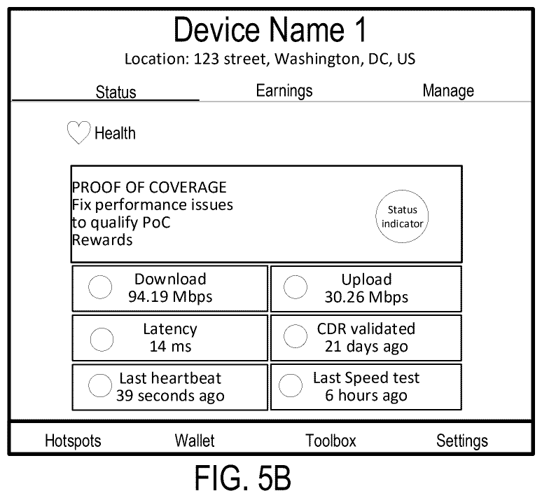

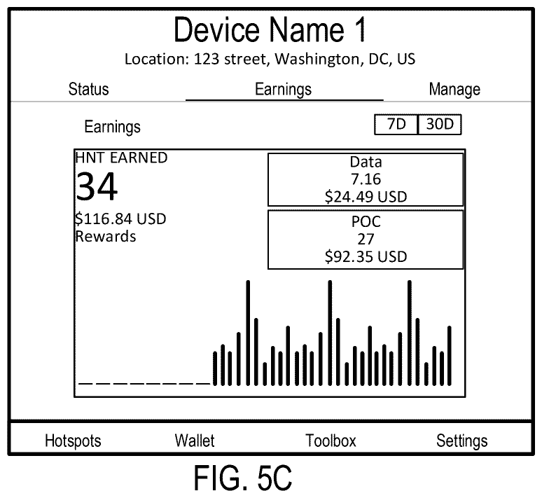

Aspects of FIGS. 5A-C described herein provide an example interface relating to fleet management application 112. Aspects of FIG. 5A provide an example of a specific interface for fleet management application 112 that displays a user's fleet of mobile hotspot devices. Aspects of FIG. 5A may provide a current location of the mobile hotspot device. Aspects of FIG. 5B provide an example interface of the fleet management application concerning the status of a particular mobile hotspot device in the fleet. The example interface of FIG. 5B may provide the status of the first device, which may include: download/upload speed, latency, CDR validated, last heartbeat, and last speed test. Aspects of FIG. 5C provide an example interface concerning the earnings of a particular mobile hotspot device. The example interface of FIG. 5C may display the earnings of the mobile hotspot device over a certain period of time (e.g., 7 days or 30 days). For a given period of time, the example interface of 5C may show the total earnings, and may include a conversion to united states dollar or other suitable currency. The example interface of FIG. 5C may provide the rewards specifically tied to data usage and the rewards tied to proof of coverage rewards and may further provide a bar chart indicating reward earnings over a period of time (e.g., daily, hourly). The bar chart may provide a distinction for a particular period that shows a user the amount that was earned by data usage and the amount that was earned by proof of coverage.

Aspects of the interface for fleet management application 112 may determine quality of service and anti-gaming metrics for each mobile hotspot device based on monitoring data received from backend servers 120. The quality of service and anti-gaming metrics may be based on (i) device heartbeat test results, (ii) backhaul speed test results, and/or (iii) location verification test results. Quality of service testing may be performed based on the device location and/or the device backhaul quality. Further, proof of coverage may be based on the verified location of the mobile hotspot device 101.

Further, blockchain 130 may receive, from the backend server 120, data indicating data transfer-based rewards to be paid out to respective users and viewable by the user in the interface of FIG. 5C. Additionally, the quality of service and anti-gaming metrics may also be used to determine coverage-based rewards to be paid out to respective users and similarly viewable by the user in the interface of FIG. 5C. Coverage-based rewards for a mobile hotspot device may be verified based on utilizing the location verification service 107. Additionally, the mobile hotspot device 101 may earn tokens based on every gigabyte of traffic consumed by user devices connected to the mobile hotspot device 101. In the context of rewards, security framework 102 may be particularly important to ensure the only data reported to the blockchain concerning user rewards is data that was actually consumed by a real user of the MVNO mobile network and/or a real user of a partner MNO.

Aspects of the fleet management application 112 described herein provide mobile hotspot device onboarding and processing of mobile hotspot device ownership for storage on blockchain 130. The mobile hotspot device ownership may be stored on the blockchain as a non-fungible token (NFT) associated with a public key identifier. The public key identifier is associated with the private key pair used in digital signatures by the mobile hotspot device. From this framework, aspects of blockchain 114 may facilitate transferring ownership of the NFT to a new owner.

FIGS. 6 and 7 illustrate aspects of a manufacturing process for newly manufactured hotspot devices. After the MVNO requests a new batch of hotspot devices from a manufacturer, the manufacturer will request MFR data (e.g., QR codes associated with each device, serial numbers, SSID/Passwords of the on-boarding network for each device). The MVNO may generate the appropriate MFR data for the manufacturer who will then begin production of the mobile hotspot devices. The process may proceed with several steps: checking the license, generating a infrastructure private key, generating a blockchain private key, generating a CSR for certification, generating onboarding transaction data with a known wallet, and create post-MFR file with all the previous data.

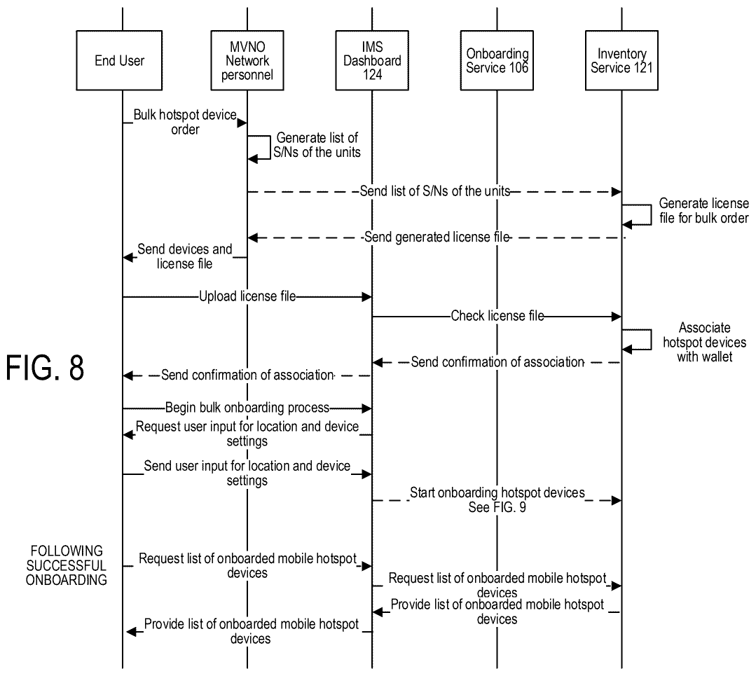

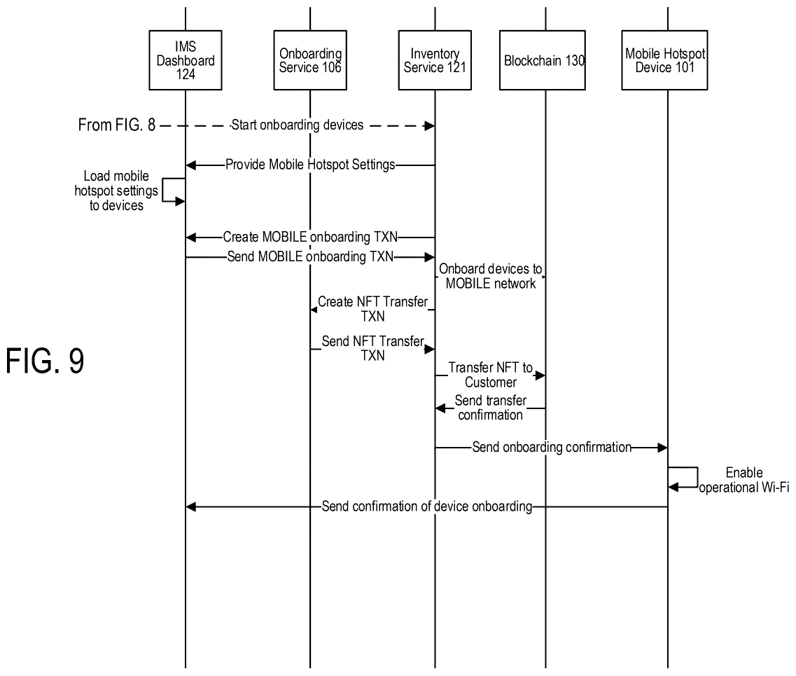

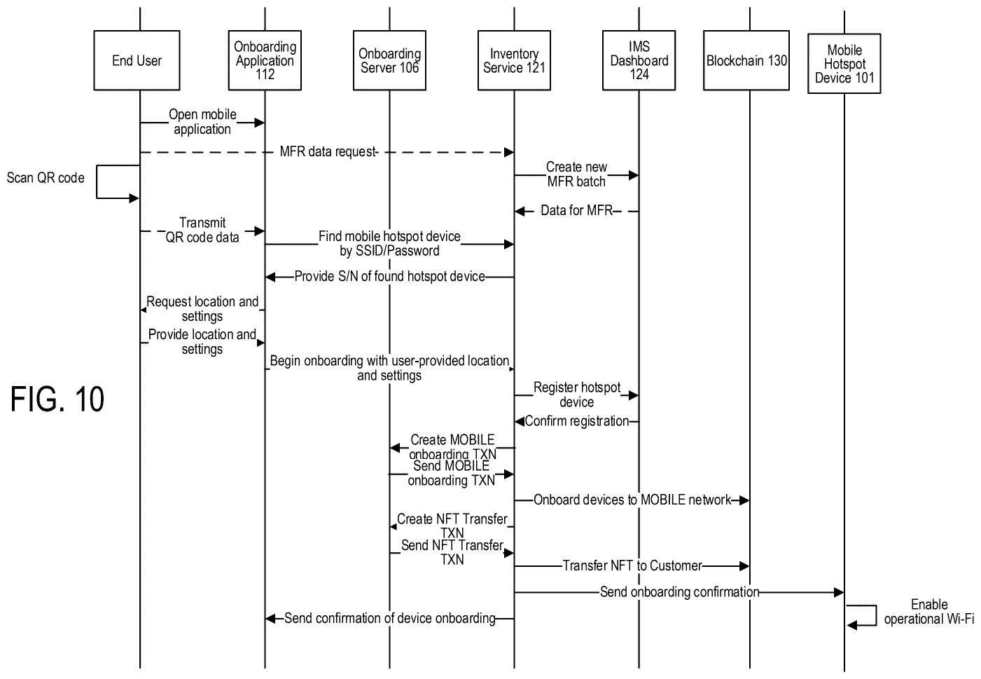

The MVNO may then receive the batch of mobile hotspot devices and validate the devices by communicating with validation service 128 and the results may be provided to the manufacturer if desired. If validation is successful, in FIG. 7 inventory service 121 may then register the new devices. The registration process may be performed asynchronously with other capabilities of inventory service 121. Inventory service 121 may communicate with the certificate service 126 to request a certificate associated with the devices. Certificate service 126 may generate and send the certificate to inventory service 121. Then, inventory service 121 may register the devices with IMS dashboard 124. Then inventory service 121 may communicate with onboarding service 106 to generate and store whitelisted devices and also create NFT transaction data. The onboarding service 106 may then provide the NFT transaction data, which may then be sent to blockchain 130 that may generate an NFT for the mobile hotspot device. At this point, the NFT is paired with a secure wallet controlled by the MVNO, and the inventory service 121 may wait to finalize onboarding until an end user purchases a mobile hotspot device, described below in FIG. 10. At that point inventory service 121 may communicate with blockchain 130 to transfer the NFT to the purchasing end user. Each mobile hotspot device that is manufactured may go through the manufacturing process and then will either be implemented by an end user through the bulk-type onboarding process (FIGS. 8-9) or the individual device-type onboarding process (FIG. 10)

FIGS. 8 and 9 illustrate aspects of a bulk-type onboarding process, where an end user bulk orders and onboards numerous mobile hotspot devices. First, the MVNO may communicate with inventory service 121 to generate a license file, which may include a list of serial numbers for mobile hotspot devices in the order. The end user may, upon receiving the order may open the fleet management application 112 and upload the generated license file. Fleet management application 112 may communicate with inventory service 121 to validate the license file, at which point inventory service 121 may associate each mobile hotspot device from the license file with the end user's digital wallet.

At this point, the end user may begin onboarding the mobile hotspot devices by selecting any particular number of the total mobile hotspot devices displayed on the fleet management application 112. Following selection of mobile hotspot devices to onboard, fleet management application 112 may request the end user to set a location and device settings for each mobile hotspot device. After receiving the user inputs for location and device settings, fleet management application 112 may communicate with inventory service 121 to start the bulk-type onboarding process. The inventory service 121 may communicate the mobile hotspot settings to be installed on each mobile hotspot device to IMS dashboard 124. The inventory service 121 may then communicate with the onboarding service 106 to generate and receive a MOBILE onboarding transaction data, which may contain the specified location set by the end user. The inventory service 121 may communicate with blockchain 130 to onboard the mobile hotspot device to MOBILE network. The inventory service 121 may then communicate with the onboarding service 106 to generate and receive the NFT transaction data, which is then provided to blockchain 130 to transfer the NFT to the customer. The fleet management application 112 may query the inventory service 121 for the current state of the bulk-type onboarding process. Upon successful transfer of the NFT to the end user, the inventory service may communicate with the specific mobile hotspot device to enable operational Wi-Fi in that device. The mobile hotspot device 101 may then provide the fleet management application with confirmation of the device onboarding.

FIG. 10 is a diagram illustrating aspects of an individual device-type onboarding process, where an end user is onboarding a single mobile hotspot device. Once the user receives the unit, user may open fleet management application 112 and may scan a QR code associated with the mobile hotspot device. The QR code may cause the fleet management application to communicate with the inventory service 121 to identify the proper SSID/Password combo for the mobile hotspot device. Further, the SSID/Password combination may be replaced by using a randomized UUID or randomized combination of words and numbers. The fleet management application 112 may receive the associated SSID/Password from the inventory service 121, at which point the fleet management application 112 may request the end user to specify the location and device settings of the mobile hotspot device. After receiving the user input, the fleet management application 112 may communicate with the inventory service 121 to perform onboarding of the device with the user input. The inventory service 121 receives the user inputs and communicates with the IMS dashboard 124 to store the location and device settings. The inventory service 121 may then communicate with the onboarding service 106 to generate and receive a MOBILE onboarding transaction data, which may then be provided to the blockchain 114 to onboard the mobile hotspot device 102 to MOBILE network. The inventory service may then communicate with the onboarding server to generate and receive the NFT Transfer transaction data, which may then be used by the blockchain 114 to transfer the NFT to the end user's wallet. The inventory service may then communicate with the mobile hotspot device to cause the mobile hotspot device to enable the operational Wi-Fi. The inventory service may communicate with the fleet management application which may then display a message to the user indicating completion of the mobile hotspot device onboarding.

From the perspective of the backend systems 120 of the MVNO, the mobile hotspot device may be partially onboarded to the blockchain prior to arrival at the user's location as previously described above. Thus, when a user initially receives the mobile hotspot device, it may be partially onboarded and the user may complete the individual device-type onboarding process to create a user identity for the blockchain. The backend systems of the MVNO may perform the combination of the mobile hotspot device onboarding and the subscriber onboarding, which is a secure process because the mobile hotspot device 101 provides on-boarding specific Wi-Fi that may only be generated with connection to the QR code. This may prove to the MVNO the user is the actual owner of the mobile hotspot device. Once the blockchain is setup with the public-private key pair, the MVNO backend systems may trust the user identity and assign NFT on the blockchain to the user's identity.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity-which resides across all physical networks.

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein.

One or more aspects described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

What is claimed is:

1. A method, comprising:
receiving, by a computing device, a connection request from a user device;
determining, by the computing device, credentials for a first Wi-Fi signal, wherein the first Wi-Fi signal is associated with registering the computing device with a database;
broadcasting, based on the determined credentials, the first Wi-Fi signal;
causing output of an interface indicating:
a location of the computing device; and
selection of device settings by a user of the user device;
receiving, via the interface, the location of the computing device and the user-selected device settings;
generating, by the computing device, onboarding transaction data and ownership transfer transaction data;
sending, to the database, the onboarding transaction data and the ownership transfer transaction data;
generating, by the computing device, a second Wi-Fi signal.

2. The method of claim 1, further comprising:
receiving, from each of a plurality of user devices, a connection request for the respective user device to connect with the computing device;
authenticating, by the computing device, each of the plurality of user devices; and
sending, to each of the plurality of user devices, a message that causes each of the plurality of user devices to connect to the computing device using the second Wi-Fi signal.

3. The method of claim 1, wherein the interface indicates an option for the user device to select a location of the computing device.

4. The method of claim 1, wherein the device settings comprise one of: configuration settings, monitoring settings, testing settings.

5. The method of claim 1, wherein the user device comprises one of: a cell phone, a tablet, a laptop.

6. The method of claim 1, wherein the ownership transfer transaction data indicates data for generating a non-fungible token on a decentralized database.

7. The method of claim 1, wherein the onboarding transaction data comprises data indicating the computing device is registered with a network, wherein the network is a cellular network.

8. The method of claim 7, wherein the first and second Wi-Fi signal are broadcast using cellular data of the cellular network.

9. A method, comprising:
receiving, from a server, first data indicating a plurality of wallet addresses on a blockchain associated with a plurality of computing devices, wherein the plurality of computing devices broadcast a data signal for a plurality of user devices connected to the plurality of computing devices;
generating a non-fungible token for each computing device of the plurality of computing devices;
associating the non-fungible token for each computing device with the wallet address of each computing device;
receiving, from the server, second data indicating data usage of the plurality of user devices connected to the plurality of computing devices;
determining, based on the second data and for each computing device of the plurality of computing devices, the respective data usage of the plurality of user devices;
determining, based on the respective data usage of the plurality of user devices and for each computing device, one or more rewards; and
sending, to each computing device, the one or more rewards.

10. The method of claim 9, wherein the second data comprises call data records for the plurality of user devices.

11. The method of claim 11, wherein the call data records indicate, for each user device, one of:
call records;
SMS text communication records; and
data usage records.

12. The method of claim 9, wherein the one or more rewards are the one or more first rewards, further comprising:
receiving, for each user device of the plurality of user devices, device metric data from one of:
a heartbeat service;
a speedtest service; and
a location service;
determining, based on the device metric data, one or more second rewards; and
generating a message indicating the one or more second rewards.

13. The method of claim 12, wherein the plurality of wallet addresses are associated with ownership information for the plurality of computing devices.

14. The method of claim 9, wherein the plurality of user devices are owned by a first network and the plurality of computing devices are owned by a second network, further comprising:
sending, to the first network, the respective data usage of the plurality of user devices owned by the first network;
allocating, based on a payment by the first network, a portion of the payment to the plurality of computing devices.

15. The method of claim 9, wherein the plurality of user devices each comprise at least one of: a cell phone, a tablet, a laptop.

16. The method of claim 9, further comprising:
receiving, from the server, third data indicating a new wallet address for one of the plurality of computing devices;
determining, the non-fungible token associated with the respective wallet address of the plurality of wallet addresses;
causing the non-fungible token to be associated with the new wallet address for one of the plurality of computing devices.

17. The method of claim 9, wherein the generating a message causes output of the one or more rewards to the respective user devices.

18. A system, comprising:
a de-centralized server; and
a plurality of computing devices;
wherein the de-centralized server comprises:
one or more processors; and
memory storing instructions that, when executed by the one or more processors, cause the security computing device to:
receiving, from a server, first data indicating a plurality of wallet addresses on a blockchain associated with a plurality of computing devices, wherein the plurality of computing devices broadcast a data signal for a plurality of user devices connected to the plurality of computing devices;
generating a non-fungible token for each computing device of the plurality of computing devices;
associating the non-fungible token for each computing device with the wallet address of each computing device;
receiving, from the server, second data indicating data usage of the plurality of user devices connected to the plurality of computing devices;
determining, based on the second data and for each computing device of the plurality of computing devices, the respective data usage of the plurality of user devices;
determining, based on the respective data usage of the plurality of user devices and for each computing device, one or more rewards;
sending, to each computing device, the one or more rewards. each of the plurality of computing devices comprising:
at least one second processor; and
a second memory storing second instructions that, when executed by the at least one second processor, configure each of the plurality of user devices to:
receive, from the de-centralized server, one or more rewards.

19. The system of claim 18, wherein each user device of the plurality of user devices comprises one of: a cell phone, a tablet, a laptop.

20. The system of claim 18, wherein the second data indicates device metrics from one of: a heartbeat service, a speedtest service, a location service.
